(19) United States
(12) Patent Application Publication
(10) Pub. No.: US 2023/0278049 A1
(43) Pub. Date: Sep. 7, 2023

(54) CONE SPRAY NOZZLE

(71) Applicant: SOLCERA, Evreux (FR)

(72) Inventor: Hervé FOUBERT, Evreux (FR)

(73) Assignee: SOLCERA, Evreux (FR)

(21) Appl. No.: 18/110,562

(22) Filed: Feb. 16, 2023

(30) Foreign Application Priority Data
Feb. 16, 2022 (FR) 2201365

(51) Int. Cl. B05B 7/04; B05B 7/10

(52) U.S. Cl. CPC B05B 7/0483; B05B 7/10

(57) ABSTRACT

A conical-jet spray nozzle (1) comprises a body (2), of generally axisymmetric shape, with an inlet zone (11) for liquid and an outlet (12), and a core (3), at least partially housed in the body (2). The core (3) is arranged so as to mix the liquid passing through it with air, upstream from the outlet (12). The nozzle (1) further comprising an additional part (5), disposed downstream from the inlet face (11) and upstream from the core (3). This additional part (5) is arranged so as to gyrate a liquid jet about the axis (XX′) of the body (2).

### FIELD OF THE INVENTION

The invention relates to a spray nozzle, in particular for agricultural use.

### BACKGROUND

In this field, particularly for spreading purposes, sprayers comprising one or more ramps, or atomizers, which can each be equipped with several tens of nozzles, are used. These nozzles are intended to work simultaneously, at pressures between 3 and 20 bar.

Each nozzle, also known as “injector” in the art, is designed so as to project a generally conical jet of droplets, capable of producing on a plane perpendicular to the projection direction a circular spraying ring (referred to as “hollow cone” or a disk (solid surface with a circular contour, referred to as “solid cone”).

In this context, effective spraying is sought, which means, in respect of the nozzles, a target droplet spectrum, a calibrated flow rate at a nominal operating pressure and a specific jet angle (angle at the apex of the cone formed by the jet at the nozzle outlet). The droplet spectrum corresponds to the distribution of the sprayed droplets according to the size thereof.

The nozzles are designed in such a way that the fluid, once the flow rate has been calibrated, passes through a decompression chamber where it is mixed with air. The air-liquid mixture is created inside a Venturi-effect part, referred to as “cover” or “core” in the art, and which operates, more frequently, by the Venturi effect.

The design of a spray nozzle must make it possible to control the size of the droplets of the outlet jet. Within the scope of an agricultural application, the reference is ASABE S 572.1 standardization. Droplet size classes range from the description “very fine” (category “VF”) to “ultra-coarse” (category “UC”). The invention focuses on the production of droplets from “medium” (category “M”) and beyond. The design must furthermore observe a target jet angle and allow maintained priming for pressures particularly greater than 6 bar.

To calibrate the flow rate of the fluid passing through the nozzle, the latter is arranged such that the fluid passes through, at the nozzle inlet, or in the vicinity thereof, an orifice at a suitable size for this flow rate. Most frequently, this calibration orifice is arranged through a disk-shaped part, referred to as “nozzle disk” in the art. Reference is thus made to “calibration nozzle disk”.

For low flow rates, nozzle disks are provided wherein the calibration orifice is relatively narrow, or vice versa.

To prevent, in use, the nozzle from being clogged in an untimely manner, or at least reduce this risk, the fluid is generally filtered upstream from the nozzle. Filters with mesh sizes are used wherein the size corresponds to that of the calibration orifices, with lower values.

For example, it is customary to use, for nozzles with lower flow rates (ISO flow rate range between 0050 and 0075), filters of very fine mesh size, between 100 mesh and 200 mesh. On account of the very fine mesh size thereof, these filters are particularly susceptible to clogging.

In other words, the risk of clogging the nozzles is reduced by transferring this risk to the filters disposed upstream. However, when a filter is clogged, the nozzle located downstream is no longer operational.

The aim of the invention is that of improving the situation, and in particular of reducing overall the risk of clogging of the filter-nozzle assemblies.

The risk of clogging of the filters or the nozzles is particularly present in the agricultural field, in that the product to be sprayed is generally in the form of a suspension, more or less concentrated. However, the invention is not intended to be limited to this field. The invention applies, on the contrary, to any field where hollow or solid cone spray nozzles are used, and where there is a risk of clogging of these nozzles, even if, where applicable, this risk proves to be lower than in the agricultural field. The invention also applies in fields where nozzles are used in a closed or controlled environment. In a non-limiting manner, the invention also finds applications in the agri-food field and industry, in particular in the field of surface protection.

However, systems having the sole aim of using hollow-cone nozzles for calibrating a flow rate within a system supplying air by forced natural convection do not fall within the scope of the invention.

### SUMMARY

A conical-jet spray nozzle is proposed, of the type comprising a body, of generally axisymmetric shape, with an inlet zone for liquid and an outlet, and a core, at least partially housed in the body, arranged so as to mix the liquid passing through it with air, upstream from the outlet. The nozzle further comprises an additional part, disposed downstream from the inlet face and upstream from the core. This additional part is arranged so as to gyrate a liquid jet about the axis of the body.

The additional part, which can be referred to as “swirl”, is arranged, and in particular, dimensioned, so as to calibrate the liquid passing through the nozzle.

The proposed nozzle has a reduced risk of clogging in relation to conventional nozzles, particularly those comprising a calibration nozzle disk upstream from the core, optionally supplemented, downstream, with a buffer, a diffuser and/or a discharge disk. On account of this reduced risk, the proposed nozzle can be associated with a coarser filter than conventional nozzles, thus reducing the clogging risk of the nozzle and filter assembly. This combination is particularly relevant for nozzles intended to work in ISO flow rate ranges between 0050 and 02.

Unlike conventional nozzles, the proposed nozzle does not reproduce the principle of a calibration of the flow rate by means of a nozzle disk or, more generally, the passage of the fluid through a calibration orifice. As a replacement, the proposed nozzle uses a gyration-effect part.

Additional or alternative optional features of the invention are listed hereinafter.

The additional part comprises a chamber, having a revolving shape, and at least one intake channel for liquid, each intake channel opening into the chamber tangentially.

The additional part further comprises a discharge conduit, wherein the chamber opens axially, and this discharge conduit has cross-section dimensions each greater than the cross-section dimensions of each of the intake channels.

Each intake channel of the additional part has cross-section dimensions each greater than the diameter of a calibration nozzle disk of equivalent flow rate.

Each intake channel of the additional part has as a cross-section a minimal dimension, and this minimal dimension is greater than the diameter of the calibration nozzle disk of equivalent flow rate, of at least ten per cent.

The core has a decompression chamber, capable of mixing a liquid jet with ambient air, and at least one intake conduit for the liquid, which opens into this decompression chamber. The core is disposed relative to the additional part such that the intake conduit of this core is coaxial with an outlet of the additional part.

The intake conduit of the core has cross-section dimensions less than those of the decompression chamber.

The intake conduit of the core has cross-section dimensions greater than those of the outlet of the additional part.

The dimensions of the cross-section of the intake conduit of the core and a length of this conduit are chosen together so as to maintain a jet angle at the outlet close to 30 degrees.

The core further comprises an outlet pipe, which flares in the manner of a duct along the axis of the body. This outlet pipe is dimensions so as to increase the flaring of the fluid.

The nozzle is devoid of a part having the function of channeling a tangential velocity of the liquid, at least downstream from the core. The nozzle further comprises a discharge part, housed in the body, downstream from the core and upstream from the outlet.

The discharge part comprises an elongated chamber. This chamber has cross-section dimensions and a length adapted according to a sought jet angle at the outlet.

The nozzle further comprises a second additional part, having the function of channeling a tangential velocity of the fluid in the jet. The second additional part is housed in the body, downstream from the core.

The nozzle further comprises a disk-shaped discharge part, downstream from said second additional part. This discharge part is housed in the body in such a way that a space is arranged, in said body, between the second additional part and the discharge disk.

The space extends over a distance along the axis of the body of close to 1 millimeter.

The nozzle is devoid of a discharge part and of a part having the effect of channeling a tangential velocity of the fluid in the jet. The core comprises a part forming a duct. The dimensions of this duct are adapted so as to produce at the outlet a conical jet wherein the angle at the apex is between 15 and 40 degrees.

### BRIEF DESCRIPTION OF THE DRAWINGS

Further features and advantages of the invention will become apparent on reading the following detailed description, with reference to the drawings, wherein:

FIG. 1 represents an exploded view of a nozzle according to the invention, as a perspective view;

FIG. 2 represent the exploded view of FIG. 1, as a front view;

FIG. 3 represents the exploded via of FIG. 1, as a side view;

FIG. 4 represents the nozzle of FIG. 1, mounted, as a front view;

FIG. 5 represents the nozzle of FIG. 4, as a cross-section along a line V-V;

FIG. 6 represents the nozzle of FIG. 5, as a cross-section along a line VI-VI;

FIG. 7 represents the nozzle of FIG. 4, as a top view;

FIG. 8 represents the nozzle of FIG. 5, as a perspective view;

FIG. 9 represents a part acting as a swirl for the nozzle of FIG. 1, as a top view;

FIG. 10 represents a part acting as a diffuser for the nozzle of FIG. 1, as a perspective view;

FIG. 11 represents the part of FIG. 10, as a bottom view;

FIG. 12 represents the part of FIG. 10, as a side view;

FIG. 13 represents the part of FIG. 10, as a perspective view;

FIG. 14 represents the swirl of FIG. 9, as a front view;

FIG. 15 represents a part acting as a cover for the nozzle of FIG. 1, as an axial cross-section;

FIG. 16 is similar to FIG. 1 for a nozzle variant according to the invention;

FIG. 17 is similar to FIG. 2 for the variant of FIG. 14;

FIG. 18 is similar to FIG. 3 for the variant of FIG. 14;

FIG. 19 is similar to FIG. 1 for a further nozzle variant according to the invention;

FIG. 20 represents the variant of FIG. 19, as an exploded and longitudinal cross-section view;

FIG. 21 represents the variant of FIG. 19, as an exploded view and along a further longitudinal cross-section;

FIG. 22 represents the variant of FIG. 19, assembled and as a longitudinal cross-section;

FIG. 23 represents the variant of FIG. 19, assembled and along a further longitudinal cross-section;

FIG. 24 is similar to FIG. 1 for a further variant of the nozzle according to the invention;

FIG. 25 is similar to FIG. 2 for the variant of FIG. 24;

FIG. 26 represents the variant of FIG. 24, as an exploded and longitudinal cross-section view;

FIG. 27 is similar to FIG. 1 for a further variant of the nozzle according to the invention;

FIG. 28 represents the variant of FIG. 27, assembled and as a longitudinal cross-section;

FIG. 29 is similar to FIG. 28, along a further longitudinal cross-section.

### DETAILED DESCRIPTION OF THE PREFERRED EMBODIMENTS

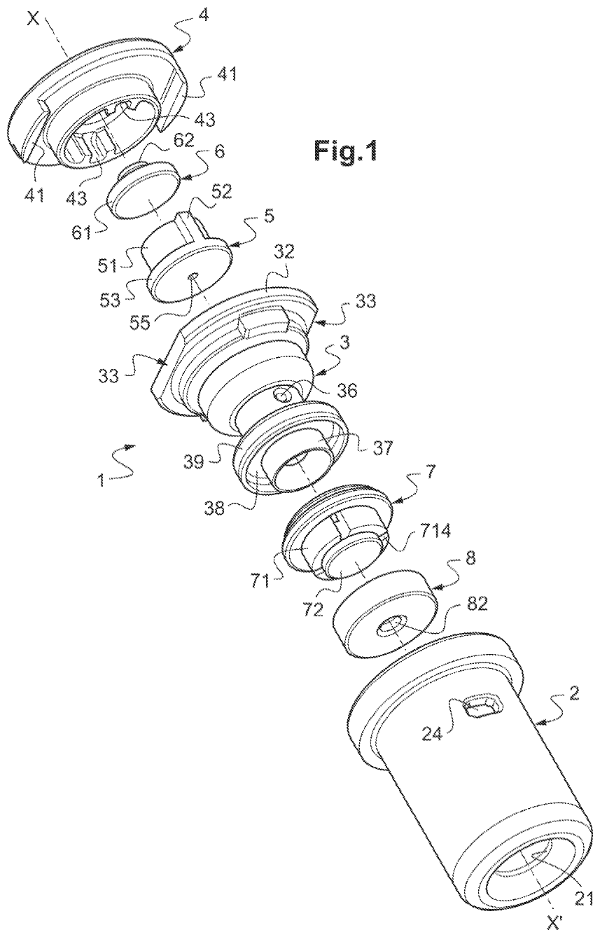

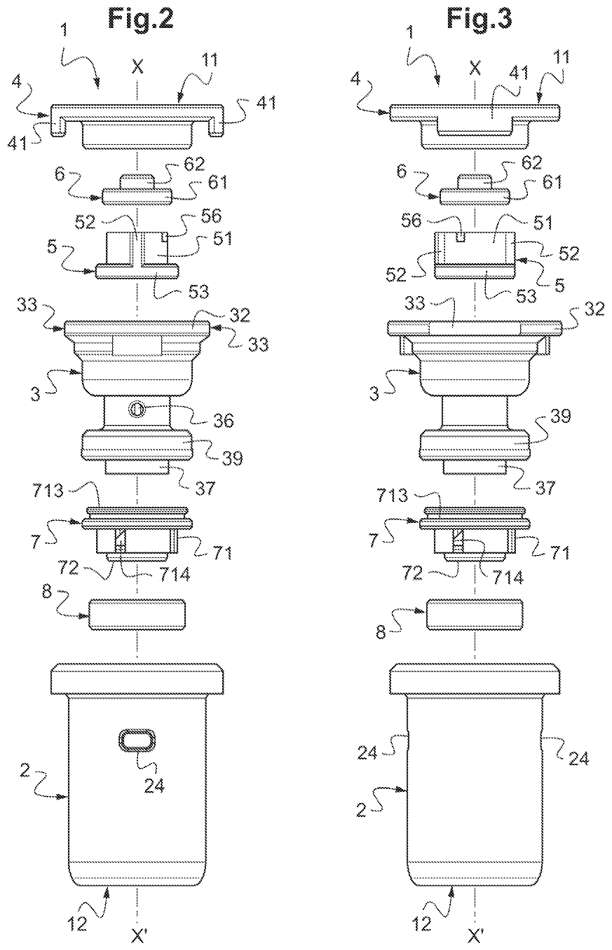

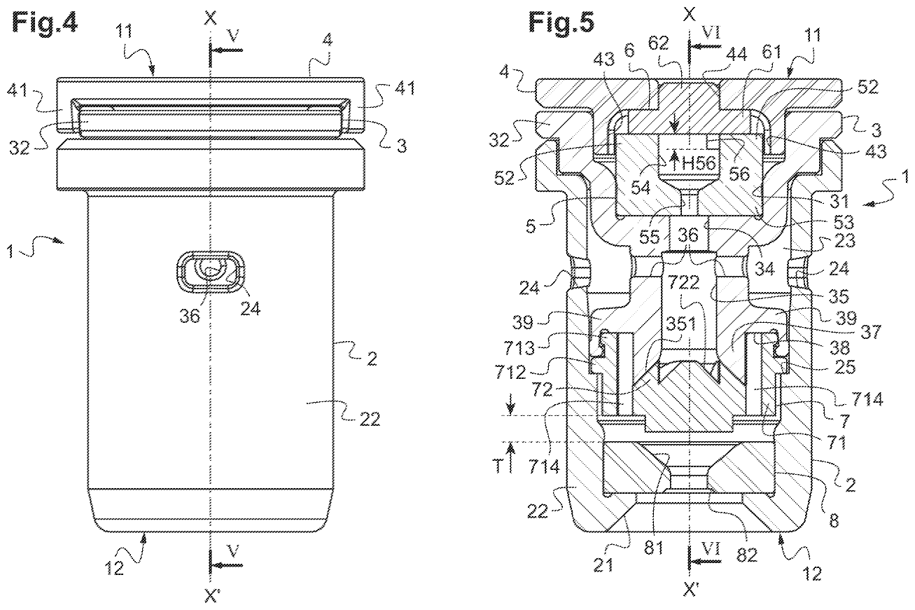

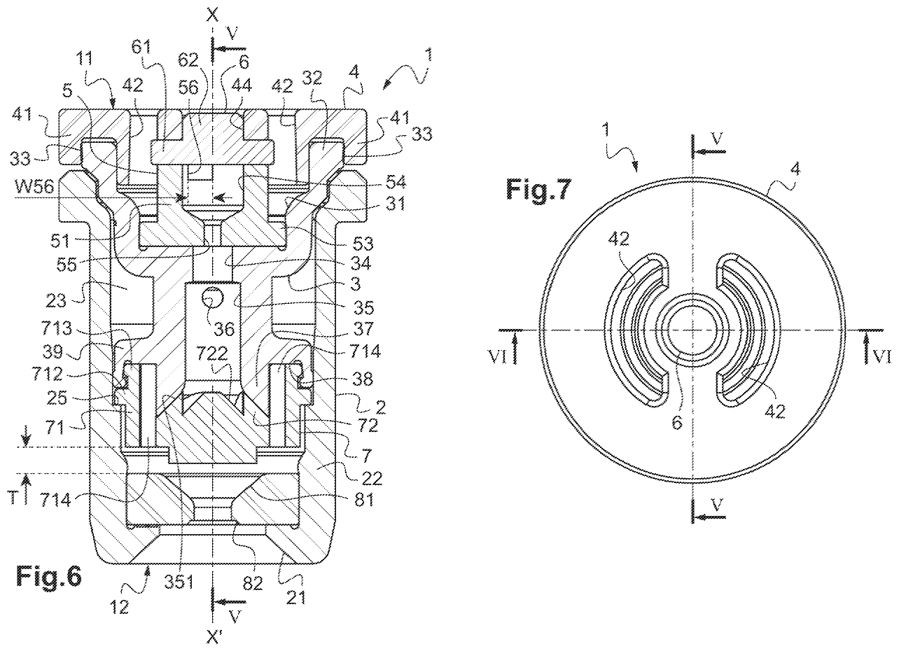

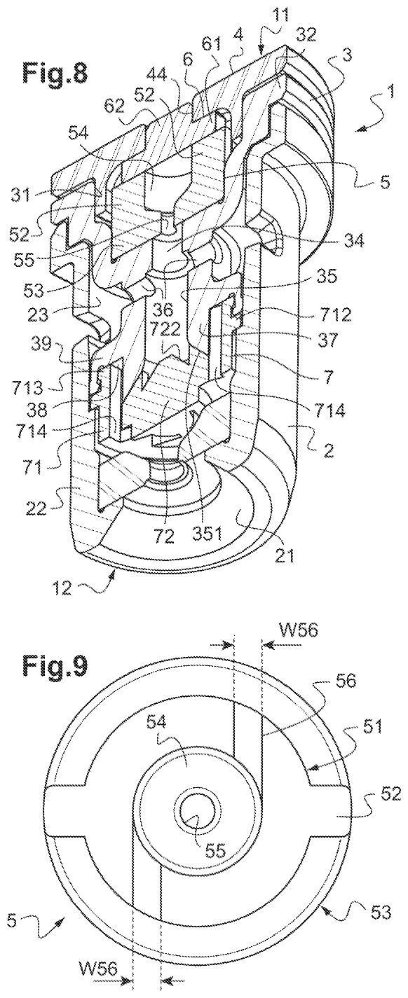

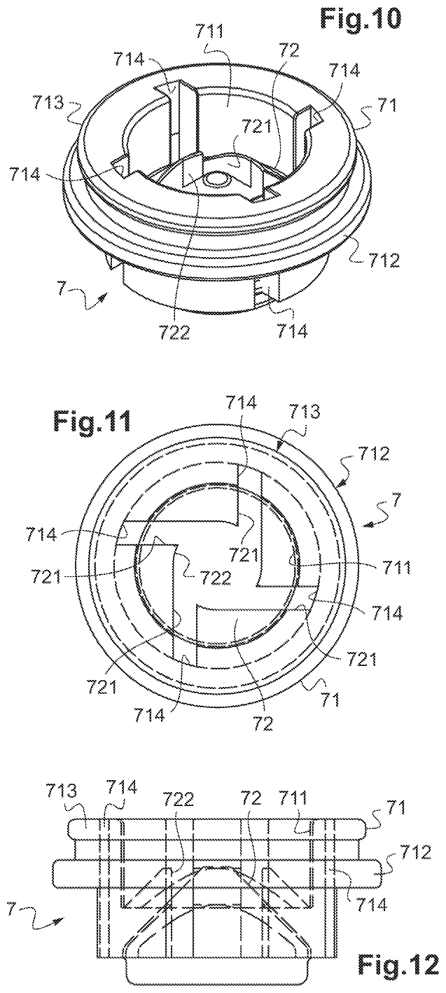

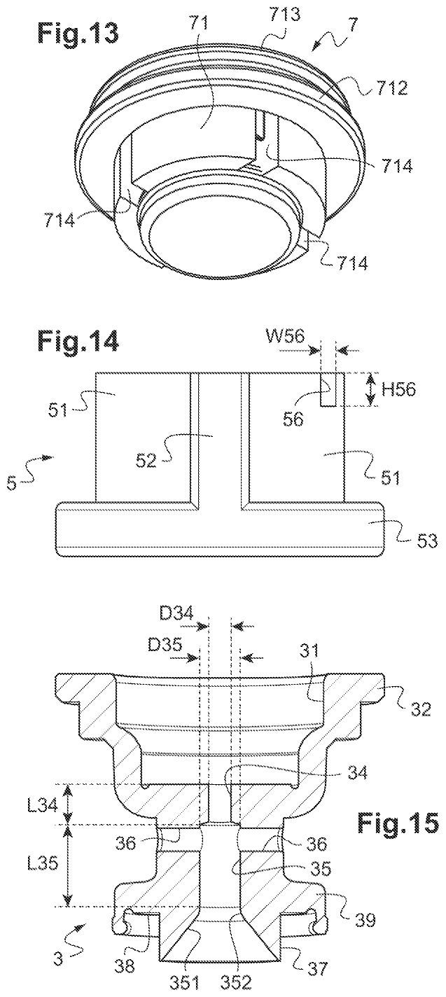

Reference is made to the figures, from FIG. 1 to FIG. 15.

A spray nozzle 1 has an inlet face 11 through which a fluid to be sprayed enters and an outlet face 12 through which the fluid is ejected from the nozzle 1. The nozzle 1 has an axisymmetric, here revolving, general appearance. The axis of symmetry or revolution is referenced XX′ in the figures. The inlet face 11 and the outlet face 12 of the nozzle 1 are mutually opposite along the direction of the axis XX′ of the nozzle 1.

The nozzle 1 is arranged in such a way as to work in a specific range of flow rates, particularly a range defined by the ISO 10625 standard. For example, the nozzle 1 is designed to work in the ISO range “01”, i.e., a flow rate of 400 cubic centimeters per minute.

Hereinafter, the terms “upstream” and “downstream” refer to a general direction of flow of the fluid inside the nozzle 1: along the axis XX′ of this nozzle 1, from the inlet face 11 to the outlet face 12.

The nozzle 1 comprises a body 2 in box or dowel form. The body 2 has an appearance of a general straight cylinder shape, delimited by an upstream face and a downstream face mutually opposite along the axis of the body 2. The downstream face of the body 2 corresponds to the outlet face 12 of the nozzle 1.

The body 2 has an outlet orifice 21, which opens onto the outlet face 12 and corresponds to the outlet of the nozzle 1. The fluid to be sprayed emerges from the nozzle 1 via the outlet orifice 21 of the body 2. The body 2 has a peripheral wall 22 which surrounds an internal space 23. This internal space 23 houses the essential elements of the nozzle 1.

The nozzle 1 further comprises a part acting as a cover 3, of general revolving appearance, with an upstream face and a downstream face mutually opposite along the axis of the cover 3. The cover 3 is mounted on the body 2 in such a way as to be housed in the internal space 23 of the body 2. The downstream face of the cover 3 is then located inside this internal space 23, whereas the upstream face thereof protrudes from the upstream face of the body 2, in the axial direction of the nozzle 1.

The cover 3 closes the internal space 23 of the body 2. The cover 3 comprises a wide open space on the upstream face thereof and which forms a cup 31, and a collar 32 which borders the cup 31 at the front face of the cover 3. In the mounted state, the collar 32 of the cover 3 protrudes from the upstream face of the body 2. The collar 32 is generally circular, with the exception of a pair of flat sections 33 disposed symmetrically in relation to the axis of the cover 3.

The cover 3, sometimes referred to as “venturi” or “core” in the art, is arranged in such a way that the fluid jet passing through it is charged with air (mixture), this air being generally aspirated by the Venturi effect.

The nozzle 1 further comprises a part acting as an outer cover 4, of general revolving appearance, with an upstream face and a downstream face mutually opposite along the axis of the outer cover 4. The upstream face of the outer cover 4 corresponds to the inlet face 11 of the nozzle 1. The outer cover 4 is mounted on the cover 3, in such a way that the downstream face thereof is located partially inside the cup 31 of the cover 3 and the upstream face thereof projects from the upstream face of the cover 3. The outer cover 4 closes the cup of the cover 3 on the upstream side thereof. On the downstream face thereof, the outer cover 4 has a pair of fastening tabs 41, which extend axially and engage with the collar 32 of the cover 3, on the flat sections 33 thereof. The tabs 41 and the flat sections 33 cooperate thanks to the shape thereof in such a way as to clip the outer cover 4 onto the cover 3. The tabs 41 extend parallel with one another and are conformed here as extra thicknesses of the outer cover 4.

The outer cover 4 further comprises a pair of open orifices 42 on the upstream face thereof and which each open onto the downstream face of the outer cover 4. The fluid to be sprayed enters the nozzle 1 through these orifices 42. The orifices 42 are conformed in mutual symmetry with respect to the axis of the nozzle. The orifices 42 extends parallel with the axis of the outer cover 4. These orifices 42 each have an oblong transversal profile, here in the form of an angular segment of a circular crown.

The nozzle 1 further comprises a part with the effect of producing a gyrating liquid jet, or swirl 5. The swirl 5 is furthermore arranged in such a way as to calibrate the fluid jet in the nozzle 1. The swirl 5 has a general revolving appearance, with an upstream face and a downstream face mutually opposite along the axis of the swirl 5.

The swirl 5 is mounted on the cover 3, in such a way that the swirl 5 is housed in the cup 31 of the cover 3, downstream from the outer cover 4 and upstream from the cover 3. The downstream face of the swirl 5 is then located in the vicinity of the bottom of the cup 31, the upstream face thereof recessed from the collar 32.

The swirl 5 has an outer surface with a first axial segment 51 in a straight cylinder shape, which extends from the upstream face thereof and toward the downstream face thereof. On this first segment 51, the swirl 5 has an external diameter less than the internal diameter of the cup 31, such that a first, substantially annular, space is arranged inside the nozzle 1, at the periphery of the swirl 5, and delimited by the wall 22 of the body 2.

The swirl 5 has a pair of ribs 52 which projects radially from the outer surface of the swirl 5. The ribs 52 extend in a rectilinear manner, parallel with the axis of the swirl 5, on the first segment 51 of the outer surface of the swirl 5. The ribs 52 are disposed in an axially symmetric manner in relation to one another. The ribs 52 share the annular space located between the swirl 5 and the cup 31 in two sectors similar to one another.

The outer cover 4 has a pair of grooves 43, corresponding in shape with the ribs 52 of the swirl 5. The ribs 52 and the grooves 43 cooperate so as to position the swirl 5 relative to the outer cover 4, in a manner such that the orifices 42 of the outer cover 4 open into the space in question, each in a respective sector. In the mounted state, the grooves 43 of the outer cover 4 are perpendicular to the orifices 42 in order to polarize these orifices 42 with respect to the angular sectors of the annular space.

The outer surface of the swirl 5 has a second axial segment 53, in straight cylinder shape, which extends from the first segment 51 to the downstream face thereof. On this second segment 53, the swirl 5 has an external diameter equal, to within any mounting gap, to the internal diameter of the cup 31, such that the swirl 5 is positioned relative to the cover 3 via this second axial segment 53.

Internally, the swirl 5 is perforated with a central conduit which extends in a substantially rectilinear manner along the axis of the swirl 5, from the upstream face thereof to the downstream face thereof. This conduit has a first axial segment, on the upstream side, that is generally cylindrical and of large diameter, which forms the chamber 54 of the swirl 5. On the downstream side, the central conduit has a second segment that is generally cylindrical and of smaller diameter, which forms the discharge conduit 55 of the swirl 5. The chamber 54 and the discharge orifice 55 are connected to one another by an insertion segment of the conduit, of generally frustoconical shape (not referenced).

The swirl 5 is also perforated with a pair of intake channels 56 for the fluid to be sprayed, each connecting in fluidic communication the chamber 54 and a respective sector of the annular space between the wall 22 of the body 2 and the periphery of the swirl 5. The intake channels 56 of the swirl 5 extend in a plane perpendicular to the axis of the swirl 5, in a rectilinear manner, and each open into the chamber 54 tangentially. These channels 56 have a rectangular cross-section, of which a height H56 corresponds to the span of this cross-section along the axis of the swirl 5 and a width W56 extending along a transverse direction. Here, the channels 56 are open via the top on the upstream face of the swirl 5. The channels 56 can be more or less inclined relative to the axis XX′ of the swirl 5. The flow rate of the fluid is calibrated by adapting the dimensions, in the cross-section, of the intake channels 56 and the discharge conduit 55 of the swirl 5.

A jet of fluid which enters the swirl 5 via the channels 56 thereof opens into the chamber 54 thereof where it is gyrated about the axis of the swirl 5. From the chamber 54, the jet reaches the discharge conduit 55 and leaves the swirl 5. Due to this conformation of the swirl 5, the jet outflowing from the swirl 5 has a conical appearance, of which the angle at the apex can be between 50 and 90 degrees. The angle at the apex sought at the outlet of the nozzle 1 is generally between 40 and 100 degrees.

The characteristics of the jet of fluid leaving the swirl 5 via the discharge conduit 55 thereof are dependent on the internal arrangement of the swirl 5, in particular the shape and dimensions of the intake channels 56 and the discharge conduit 55.

Here, the angle at the apex of the jet at the outlet of the swirl 5 is of little interest: the role of this swirl 5 consists here of calibrating the flow rate of fluid through the nozzle 1 and of imparting a gyration movement to the jet of fluid. The dimensions of the intake channels 56, as a cross-section, are close to each other and maximized so as to allow minimal filtration upstream from the nozzle 1, without increasing the risk of clogging in the nozzle 1. The angle at the apex of the conical jet leaving the swirl 5 is of little importance, like the droplet size or fluid velocity. The characteristics of the jet obtained at the outlet of the nozzle 1 are adapted by the parts of this nozzle 1 disposed downstream from the swirl 5.

The nozzle 1 further comprises a buffer 6 of general revolving appearance, with an upstream face and a downstream face mutually opposite along the axis of the buffer 6. The buffer 6 has a main portion in the form of a solid disk 61, of which one face corresponds to the downstream face of the buffer 6, and a secondary portion 62, generally cylindrical, which is connected to the solid disk 61 on a face thereof opposite the downstream face and ending on the upstream face of the buffer 6. The buffer 6 is mounted on the outer cover 4. The secondary portion of the buffer 6 is received in a hole 44 of the outer cover 4, open on the downstream face of the latter. The buffer 6 is rigidly connected to the outer cover 4, such that the disassembly thereof from the body 2 is accompanied by the removal of the buffer 6. This facilitates the cleaning of the nozzle 1.

In the mounted state, the downstream face of the buffer 6 comes into contact with the upstream face of the swirl 5. The diameter of the solid disk 61 is greater than the external diameter of the first segment 51 of the swirl 5, at least in the vicinity of the upstream face of the swirl 5. The buffer 6 closes the channels 56.

Internally, the cover 3 is traversed by a central conduit which extends, in a rectilinear manner, along the axis of the cover 3, from the upstream face of the cover 3 to the downstream face of the latter. This conduit comprises a first segment, or inlet conduit 34, which extends from the upstream face of this cover 3. The inlet conduit 34 opens at the bottom of the cup 31. This conduit 34 has a circular profile. The value of the diameter thereof is annotated as D34 and the length thereof as L34.

The central conduit of the cover 3 further comprises a second segment, extending from the inlet conduit 34, which forms a decompression chamber 35, where the jet of fluid is set to atmospheric pressure.

This decompression chamber 35 has a circular cross-section, the diameter D35 whereof is substantially greater than those of the intake conduit 34, and a length which is annotated as L35. The diameter D35 of the decompression chamber 35 and the length L35 thereof are chosen according to each other, such that a ratio of this diameter D35 to this length L35 is greater than 1 and less than 4. The value of this ratio is such that the jet entering the cover 3 through the inlet conduit 34 comes into contact with a sufficient wall length in the decompression chamber 35 to create a negative pressure downstream.

The cover 3 furthermore has a pair of intake conduits 36 for air, each connecting the exterior of the cover 3 to the decompression chamber 35, in the vicinity of where the inlet conduit 34 opens. The intake conduits 36 extend radially. In the mounted state, the intake conduits 36 place the internal space 23 of the body 2 in fluidic communication with the compression chamber 35. Facing each of the intake conduits 36, the peripheral wall 22 of the body 2 is perforated with an orifice 24 which places the exterior of the body 2 in fluidic communication with the internal space 23 thereof. The orifices 24 arranged in the peripheral wall 22 of the body 2. The internal space 23 of this body 2 and the intake conduits 36 cooperate in such a way that air can be conveyed from outside the nozzle 1 to inside the decompression chamber 35.

The central conduit of the cover 3 further comprises a third section in the form of a duct 351, which extends the chamber 35. The duct 351 has a frustoconical appearance, which flares from the decompression chamber 35 to the downstream face of the cover 3.

The intake conduits 36 open into the decompression chamber 35, in the vicinity of the end thereof close to the inlet conduit 34. These intake conduits 36 open into the conduit of the cover 3 at a distant location from the upstream face of this cover, separated from this face by the inlet conduit 34.

In the embodiment of FIGS. 1 to 15 in particular, the nozzle 1 further comprises a part having the function of channeling the tangential velocity of the fluid passing through it, or diffuser 7, of general revolving appearance, with an upstream face and a downstream face mutually opposite along the axis of the diffuser 7.

The diffuser 7 comprises an outer portion 71, of a general straight cylinder shape, and a portion in the form of a core 72, inside the outer portion 71.

The outer portion 71 has a wide opening 711 on the upstream face of the diffuser 7, here of generally cylindrical shape. The core 72 has a frustoconical appearance. The core 72 is located at the bottom of the opening of the outer portion 71, in such a way that the apex thereof is oriented towards the upstream of the diffuser 7.

Externally, the outer portion 71 of the diffuser 7 comprises an axial section conformed into a shoulder 712, and another axial section, which borders the opening 711, conformed into an outer flange 713. The flange 713 has a planar end surface, perpendicular to the axis of the diffuser 7, which corresponds to the upstream face of the diffuser 7.

The diffuser 7 includes grooves of a first type, or first grooves 714, arranged radially and which extend along the axis of the diffuser 7, here from the upstream face thereof to the downstream face thereof. The first grooves 714 open both onto the upstream face of the diffuser 7 and the downstream face thereof. The first grooves 714 are open on the opening 711 of the outer portion 71 and on the exterior thereof, at least along an axial portion of this outer portion 71 which is located upstream from the shoulder 712.

The diffuser 7 further includes grooves of a second type, or second grooves 721, arranged axially on the frustoconical portion of the core 72 and which extend tangentially to this portion. Each of these second grooves 721 opens into a hollowed central zone 722 of the core 72, on one hand, and, on the other, into a respective first groove 714. Here, this central zone 722 has a frustoconical bottom.

Each time, a first groove 714 and a respective second groove 721 form a passage which leads from the central zone 722 of the core 72 to the downstream face of the diffuser 7.

Externally, the cover 3 ends, in the vicinity of the downstream face thereof, with a cylindrical segment 37. The duct 351 is arranged in this end segment 37. On the downstream face thereof, the cover 3 has a support surface 38, perpendicular to the axis of the cover 3 and in circular crown form. The end segment 37 projects from the support surface 38. The support surface 38 surrounds the end segment 37. On the downstream face thereof, the cover 3 further includes a flange 39 which surrounds the support surface 38 and projects therefrom. The flange 39 includes a plurality of lugs (not referenced) therein.

In the mounted state, the planar end surface of the flange 713 bears against a homologous surface consisting of the support surface 38 of the cover 3. This cooperation prevents the formation of interstices and reduces the risk of leaks between the cover 3 and the diffuser 7. The flange 39 of the cover 3 engages with the outer flange 713 of the diffuser 7 to assemble the cover 3 and the diffuser 7 together. The body 2 of the nozzle 1 comprises a surface forming a shoulder 25 projecting into the internal space 23 of the body 2. The diffuser 7 bears against the shoulder 25 via a downstream face of the flange 713 thereof.

The frustoconical portion of the core 72 of the diffuser 7 is conformed in correspondence with the duct 351 of the cover 3. Once the cover 3 has been assembled with the diffuser 7, the duct 351 cooperates with the core 72 such that the fluid which leaves the duct 351 is constrained to take the passages jointly formed by the first grooves 714 and the second grooves 721 of the diffuser 7. The central zone 722 of the core 72 of the diffuser 7 is located facing the decompression chamber 35, where this chamber opens into the duct 351.

Here, the diffuser 7 is made in a one-piece manner. Alternatively, the diffuser 7 is made of at least two parts, one corresponding to the outer portion 71, the other to the core 72.

The nozzle 1 further comprises a convergence nozzle disk type part, also referred to as discharge disk 8. The disk 8 has an upstream face and a downstream face. The disk 8 is traversed by a conduit which extends in a rectilinear manner along the axis of the disk 8. This conduit has a first open axial section on the upstream face, or inlet orifice 81, that is generally frustoconical and is retracted from the upstream face of the disk 8 toward the downstream face thereof. The conduit furthermore has a second open section on the downstream face of the disk 8, which forms an outlet orifice 82. The outlet orifice 82 is generally frustoconical and flares as it approaches the downstream face of the disk 8. The inlet 81 and the outlet 82 of the disk 8 are connected to one another by an insertion section 8 of the conduit, that is generally cylindrical. The disk 8 is mounted in the body 2 of the nozzle 1. In the mounted state, the disk 8 rests on the bottom of the internal space 23 of the body 2, via the downstream face thereof. In this internal space 23, the downstream face of the diffuser 7, the upstream face of the disk 8 and the wall 22 of the body 2 delimit a substantially circular space the extent whereof along the axis XX′ of the nozzle 1 corresponds to a thickness referenced T.

A trajectory of the fluid to be sprayed through the nozzle 1, from the inlet face 11 thereof to the outlet face 12 thereof, is now described.

The fluid enters the nozzle 1 through the orifices 42 of the outer lid 4. The fluid flow reaches the substantially circular space at the periphery of the swirl 5. The flow enters the swirl 5 via the intake channels 56 and reaches the chamber 54 of the swirl 5 where the flow is rotated. The flow leaves the swirl 5 via the discharge orifice 55.

The flow comes out of the swirl 5 in the form of a hollow cone. The flow then enters the cover 3 via the inlet conduit 34 which is located coaxial to the discharge orifice 55 of the swirl 5. Beyond the inlet conduit 34 of the cover 3, the fluid reaches the decompression chamber 35 of this cover 3. The jet is charged with air while swirling. The cover 3 transforms the jet of fluid when enters in the form of a large-angle hollow cone into a hollow cone of substantially smaller angle. On account of the lack of direct air intake on the inlet conduit 34, an air recirculation is created in this conduit 34 which rises into the swirl 5, thus contributing to the formation of a hollow cone in the jet of fluid coming out of this swirl 5. On account of the presence of the inlet conduit 34 at the outlet of the swirl 5, the jet of gyrating fluid is constrained to remain within an angle limited by the diameter D34 of this conduit 34. The angle at the apex of the cone of the jet of fluid which passes through the cover 3 is between 15 and 25 degrees. The swirl 5 has a jet angle greater than these values. The angle at the apex of the jet at the outlet of the cover 3 is of little importance here: it is at the outlet of the discharge disk 8 that the angle must be conforming with the sought value. The intake conduits 36 open into the decompression chamber 35, downstream from the inlet conduit 34. On account of the difference between the diameter D34 of the inlet conduit 34 and that D35 of the decompression chamber D35, the jet of fluid comes into contact with the walls of this chamber 35 in a zone thereof distant from the inlet conduit 34. Upstream from this zone, the chamber 35 has a free contact zone where the intake conduits 36 can open and cause a negative pressure to appear therein.

At the outlet of the decompression chamber 35, the jet encounters the diffuser 7. The air-liquid mixture takes the passages arranged tangentially to the chamber to reach a second chamber, which corresponds to the substantially circular space delimited laterally by the wall 22 of the nozzle body 2 and comprised between the downstream face of the diffuser 7 and the upstream face of the discharge disk 8.

The jet consisting of an air-liquid mixture coming out of the diffuser 7 continues to gyrate in this second chamber and passes through the discharge disk 8 from the inlet 81 to the outlet 82. The fluid is accelerated therein and disintegration phenomena occur which result in the formation of a final jet, of which the flow rate, angle and droplet size characteristics correspond to the target jet.

It is now described how to dimension the main functional elements forming the nozzle 1.

A standardized flow rate is set as a parameter for the nozzle 1 (Table 1, Column I). For example, it is sought to dimension the nozzle 1 in such a way that it can function in the standardized flow rate range “01”, color code “red” (Table 1: Column I,II; Row 3), i.e., approximately 400 cubic centimeters per minute (Table 1: Column III; Row 3).

The swirl 5 is dimensioned so as to have a flow rate close to this standardized flow rate. The dimensions in question concern the cross-section of the channels 56 thereof, here the width W56 thereof and the height H56 thereof, and that of the discharge orifice 55, here the diameter D55 thereof.

The dimensions of the swirl 5 are determined so as to:

b(i) e as close as possible to one another, and

(ii) greater than the equivalent diameter of a nozzle calibration orifice of the same flow rate and angle at the apex at the corresponding outlet.

The properties of the calibration orifice of a nozzle of the same flow rate, in particular the diameter thereof, can be obtained from the numerous publications discussing this topic (see Table 1, Column XIII).

By way of example only, for an ISO 03 flow rate, the width W56 of the channels 56 of the swirl 5 can be close to 1.24 millimeters, the height H56 thereof 1.45 millimeters and the diameter D55 of the discharge orifice 1.50 millimeters.

The use of a swirl of the type of the swirl 5 to calibrate the flow rate of the nozzle 1 makes it possible to reduce the risk of clogging this nozzle 1 compared to a calibration disk.

The inlet conduit 34 of the cover 3 is dimensioned so as to keep the conical shape of the jet coming out of the swirl 5 and reduce the angle at the apex thereof. The dimensions in question concern the diameter D34 of the inlet conduit 34 and the length L34 thereof. The diameter D34 of the inlet conduit 34 of the cover 3 is substantially greater than the diameter D55 of the discharge orifice 55 of the swirl 5, and is determined in combination with the length L34 of the inlet conduit 34 in question.

The decompression chamber 35 of the cover 3 is dimensioned in such a way that:

the diameter D35 thereof is substantially greater than the diameter D34 of the inlet conduit 34, typically by 2 to 8 tenths in the diameter;

the length L35 thereof is such that a ratio of the diameter D35 of the decompression chamber 35 to the length L35 of this chamber 35 is greater than 0.5.

The value of this ratio is chosen in such a way that the jet comes into contact with the wall of this chamber 35 a sufficient length to create a negative pressure downstream from this chamber.

For example, for an ISO 03 flow rate, the diameter D55 of the discharge orifice 55 of the swirl 5 is close to 1.50 millimeters, the diameter D34 of the inlet conduit 34 of the cover 3 to 1.70 millimeters and the diameter D35 of the decompression chamber to 2.50 millimeters.

The vertical incidence of the tangential passages 713 of the diffuser 7, i.e., the inclination thereof relative to the axis XX′ of the diffuser 7 can be variable. For simplification purposes, an inclination of 45 degrees of these passages 713 can be adopted.

The cross-section of the tangential passages 713 is dimensioned in combination with the cross-section of the outlet orifice 82 of the disk 8, so as to prime the nozzle 1 in the sought pressure range and maintain the primed state of the nozzle 1. The Applicant's experiments show that the value of the ratio between the cross-section of the calibration swirl 5 and that of the tangential passages 713 of the diffuser 7 is specific to each target flow rate. The value of this ratio varies between 0.8 and 5. For example, it is close to 1.40 for a target flow rate of ISO 03.

The thickness T of the second chamber, between the bottom face of the circular section of the diffuser 7 and the upstream face of the disk 8 is adapted so as to keep the nozzle 1 in the primed state on the sought range of pressures and flow rates. For example, this distance is close to 1 millimeter.

In operation, the calibration swirl 5 and the venturi of the cover 3 cooperate to form a negative pressure in the decompression chamber 35 resulting in the appearance of a continuous flow (air-liquid) compatible with the flow rates and range of pressures.

The Applicant observed that the conventional configuration of a venturi, where the air inlet in located in the immediate vicinity of the outlet of the calibration nozzle disk, if possible in the restriction zone of the diameter of the jet at the outlet of a conduit, by retaining a homogeneous and focused jet, is not compatible with the use of a calibration swirl as is the case here. A swirl of this type produces a jet which disintegrates with a variable angle according to the dimensions chosen. Here, the calibration swirl 5 is used in combination with an inlet conduit 34 which moves the decompression chamber 35 and the air intakes 36 from the outlet of the swirl 5. In the absence of the inlet conduit 34, the jet leaving the swirl 5 could burst against the wall of the decompression chamber 35 and rise to the air inlets 36.

The presence in the nozzle 1 of one or more parts, or part portion, with a diffuser effect increases the gyration of the jet and the bursting thereof.

The presence of one or more parts, or part portion, with a discharge function, such as the nozzle disk 8 here, concentrates the jet in the upstream chamber. The nozzle disk 8 makes it possible to dimension the central air column in the liquid jet and influence the size of the droplets produced and the characteristics of the jet.

The nozzle 1 described here, from the inlet face thereof to the outlet face thereof, measures at most 25 millimeters in lengths, at least in the specific configurations to the ISO pressure ranges 0050 to 08.

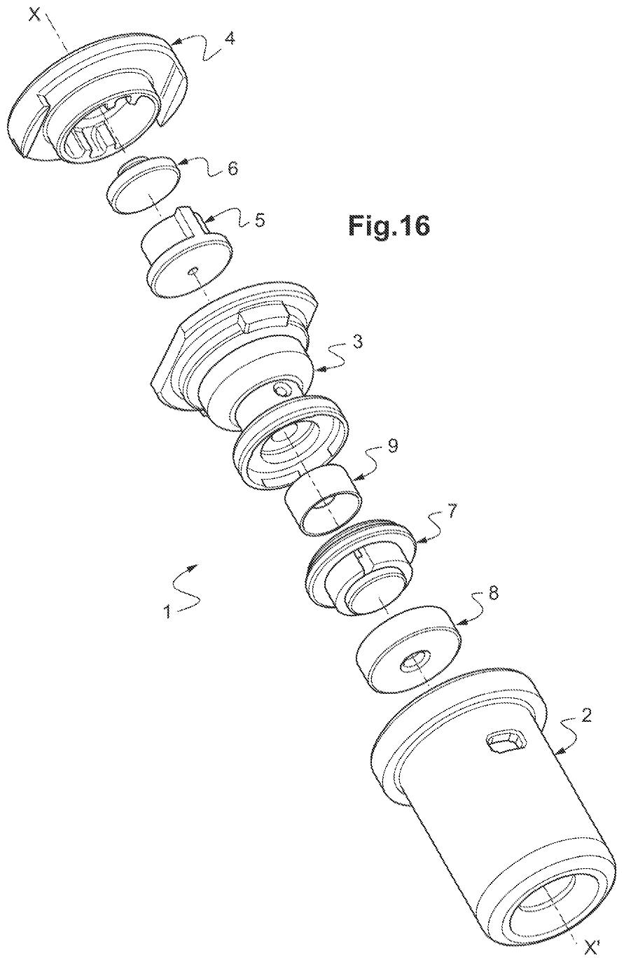

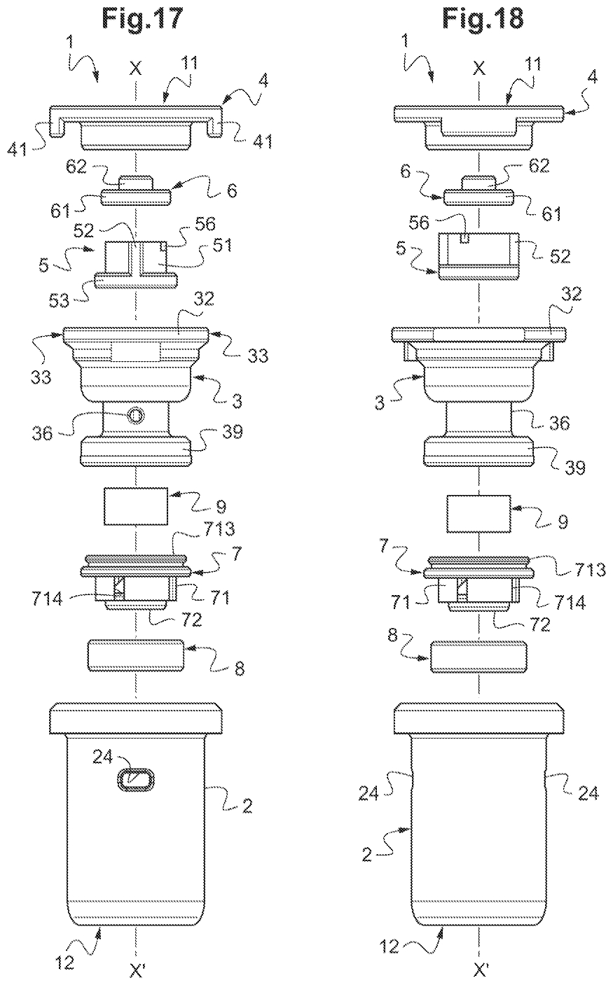

Reference is made to the figures, from FIG. 16 to FIG. 18.

The elements functionally equivalent to those of the preceding figures have the same reference numbers.

A spray nozzle 1 analogous to that described with reference to these figures differs therefrom in that the end portion of the cover 3 is made of a separate part, or over-diffuser 9. The over-diffuser 9 is preferably made of ceramic. The over-diffuser 9 can be readily changed.

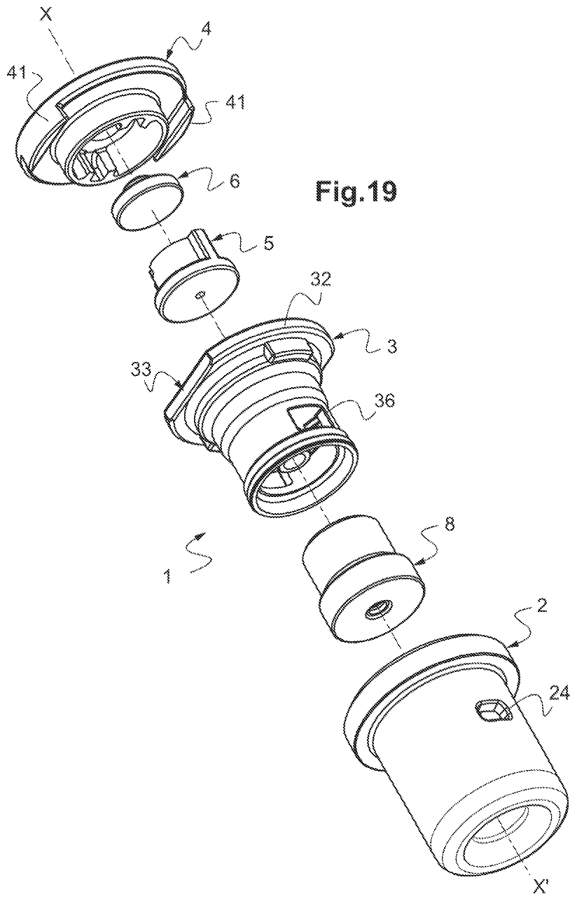

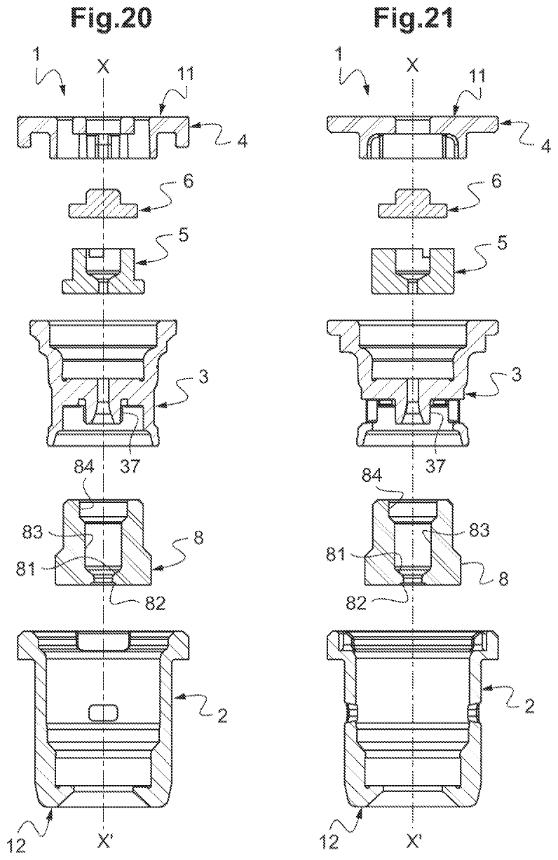

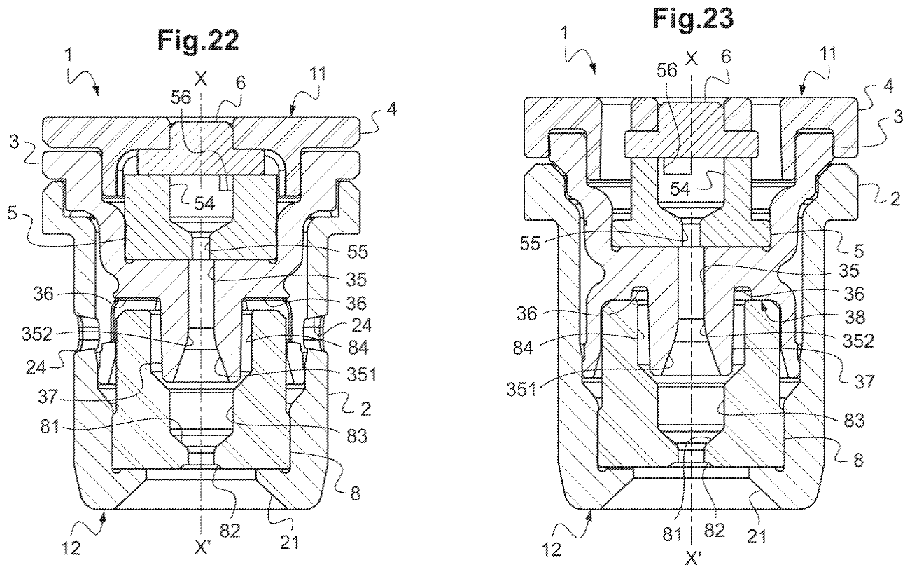

Reference is made to the figures, from FIG. 19 to FIG. 23.

The nozzle 1 is analogous to the nozzle described with reference to the figures from FIG. 1 to FIG. 15, except, firstly, that this nozzle 1 is here devoid of a part analogous to the diffuser 7. Downstream from the cover 3, the jet of fluid leaving the duct 351 directly enters a discharge part 8, of generally revolving appearance.

The presence of a part, or of a part portion, with a diffuser function, in the nozzle, as is the case for the nozzles described with reference to the preceding figures, is optional.

A bursting of the jet at the outlet of the nozzle 1 is obtained with no part with a diffuser function. To do this:

the angle at the apex of the jet at the outlet of the nozzle 1 is limited around 60 to 70 degrees; and

the angle at the apex of the jet coming out of the decompression chamber 35 is maximized around 30 to 60 degrees, this angle being greater for low flow rates, typically ISO 0050, and smaller for greater flow rates, typically greater than ISO 01 (while ensuring continuity with the duct 351 thanks to a neck 352 to prevent any loss of velocity).

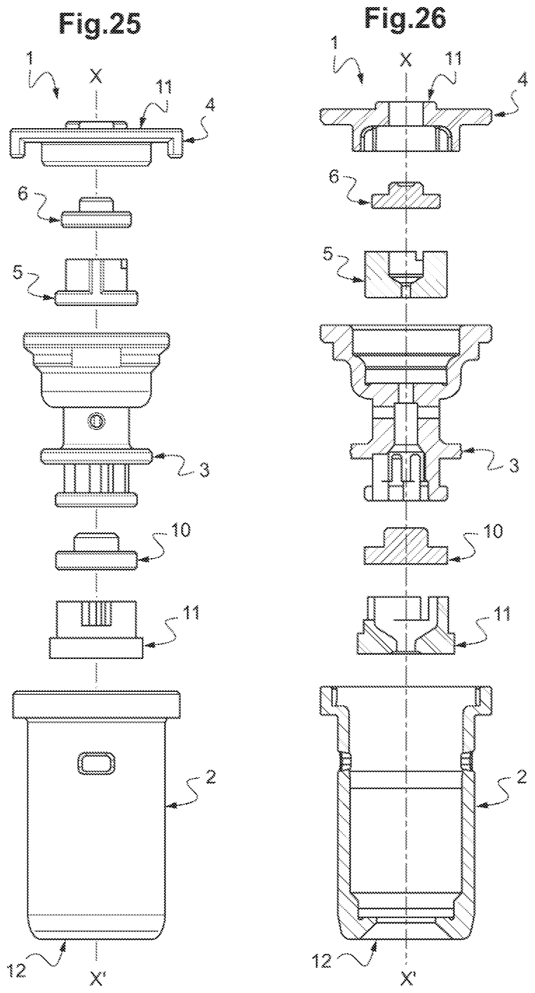

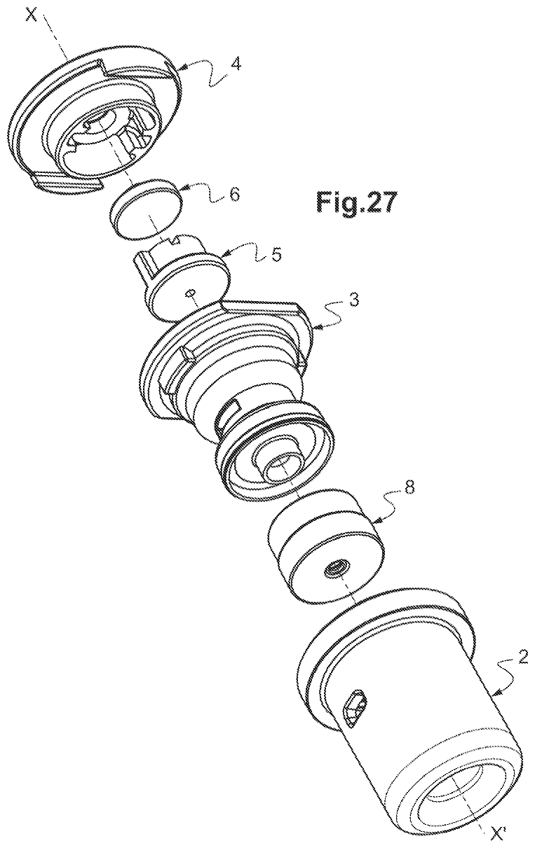

In the absence of a part with a diffuser function in the nozzle 1, as in the embodiment of FIGS. 1 to 18 and 24 to 26, the jet at the outlet of this nozzle 1 has a maximum angle at the apex which corresponds substantially to that of the jet at the outlet of the calibration swirl 5, measured with a free (isolated) jet.

A diffuser serves to communicate to the fluid jet passing through it the tangential velocity which may be lacking when the ratio of the angle at the apex of the jet sought at the outlet of the nozzle 1 to the angle at the apex obtained at the outlet of the decompression 35 is substantial.

On the same nozzle configuration, with the same parts, namely a calibration swirl 5, a cover 3 and a discharge nozzle disk 8, while retaining the mutual positioning thereof, the Applicant observed that the jet at the outlet of the nozzle 1 has an angle at the apex which can increase from 25 degrees in the absence of a diffuser to 60 degrees in the presence thereof (with water as the reference liquid).

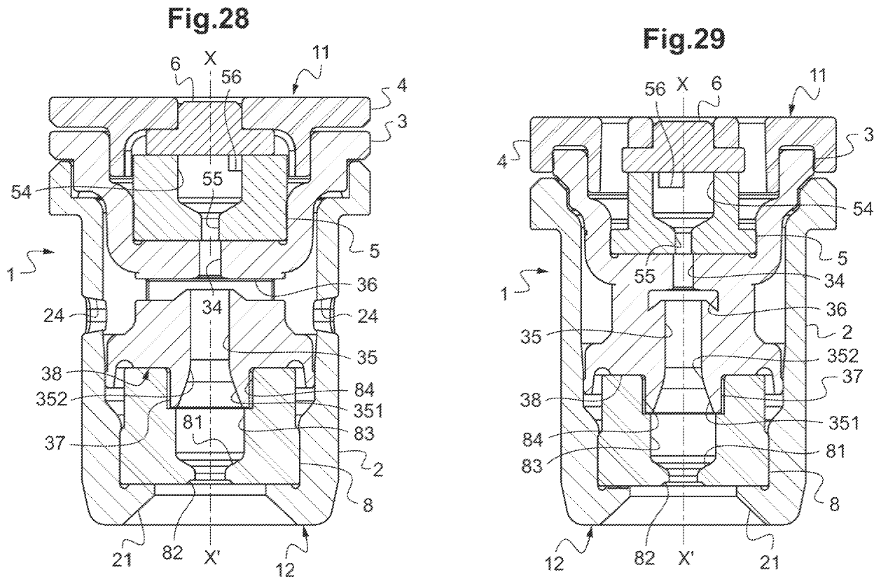

In the absence of a part with a diffuser effect, as in the embodiments of FIGS. 19 to 23 and 27 to 29 (described hereinabove), the ratio of the diameter D35 of the decompression chamber 35 to the length L35 thereof is modified, as well as the angle and the height of the duct 351 of the cover 3, with the flow radius thereof (neck 352 between the decompression chamber 35 and the duct 351), to flare the angle at the apex of the jet, thanks to the surface tension. In addition to the flaring of the duct 351, the fluid slows down on account of the fact that it is charged with air and rubs against the walls.

In this configuration with no diffuser, the part with a discharge function 8 differs from the disk described in relation to the preceding embodiments in that this part 8 integrates a discharge chamber 83, upstream from the discharge cone 82.

Here, the mixing between the external air and the jet of liquid is performed at the outlet of the cover 3, downstream from the duct 351. This air is conveyed by two wide openings 36 in the cover 3, which open in the vicinity of the cylindrical segment 37 of the cover 3.

The part 8 with a discharge function is partially received in the cover 3, in such a way that the upstream face of this part 8 bears against the support surface 38 of the cover 3. For this purpose, the part 8 is provided with an inlet orifice 84, open on the upstream face of the part 8 and which opens into the chamber 83. The inlet orifice 84 of the part with a discharge effect houses, partially at least, the cylindrical segment 37 of the cover 3. The mixing between the air and the jet of fluid leaving the duct 351 takes place in the inlet conduit 84 of the part 8, just upstream from the discharge chamber 83.

The cover 3 is then devoid of a conduit of the type of the inlet conduit 34 described with reference to the preceding embodiments. The discharge conduit 55 of the calibration swirl 5 opens directly in the decompression chamber 35 of the cover 3.

The nozzle according to the invention can be devoid of a part with a discharge function such as the disk 8 and a part with a diffuser effect, as described with reference to the preceding figures. The dimensions of the duct 351, including the neck 352 thereof, are then adapted so as to produce at the nozzle outlet a conical jet wherein the angle at the apex is between 15 and 40 degrees. In this case, the body 2 is optional. The outlet face 12 of the nozzle can correspond to a downstream face of the cover 3. The nozzle produces a spectrum of intermediate (category “M”) to coarse (category “C”) droplets, significantly larger than the spectrum of the isolated swirl 5.

In the absence of a diffuser, the tangential velocity of the fluid is closely dependent on the jet angle at the outlet of the calibration swirl 5, the diameter D34 of the inlet conduit 34 of the cover 3, where it exists, and the diameter D35 of the decompression chamber 35 of this cover 3, as well as the dimensions of the flaring of the duct 351. Such a configuration promotes intermediate droplet sizes. The presence of a diffuser adds an internal head loss while stabilizing the outlet velocities. A minimum working pressure of 5 to 6 bar can be attained, whereas this pressure can be situated between 3.5 and 5 bar in the absence of a diffuser.

Further advantages associated with the absence of diffuser are, in particular in the case of low flow rates:

a smaller discharge diameter than with the use of a diffuser (reduction of 0.1 to 0.5 millimeters);

less wear component to be matched;

a more compact nozzle;

facilitated maintenance.

Similarly, the diffuser may have a central orifice or not. The presence or not of a central orifice will have the effect of modifying the head loss induced by the gyration of the outlet flow of the decompression chamber. Reducing it makes it possible to engage the venturi at a lower pressure. This also becomes an element to be taken into account to manage the size of the droplets of the nozzle outlet jet. The internal shape of the diffuser may be supplemented by the shape described in EP 2 952 261 A1.

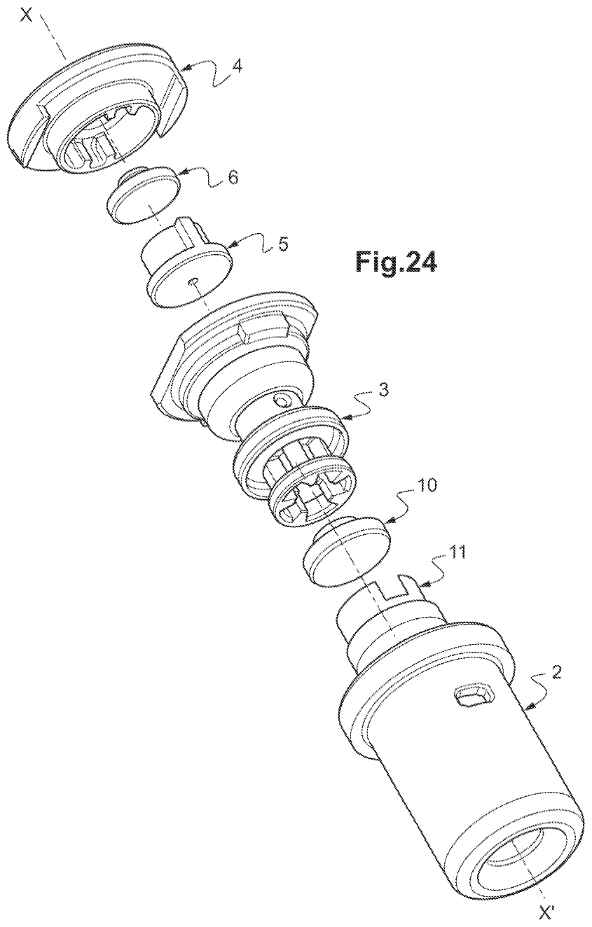

In the embodiment of FIG. 24 to FIG. 26, the passages of the cover 4 are over-dimensioned such that the cover 3 is deprived of its flow accelerator. The nozzle 1 is equipped with a swirl as a part with a discharge function. The discharge swirl 8 is arranged so as to accelerate the flow of fluid before the spraying thereof at the outlet orifice 21.

Reference is made to the figures, from FIG. 27 to FIG. 29.

In this embodiment, the nozzle 1 differs from the nozzle described with reference to FIGS. 19 to 23 in that the cover 3 is equipped with an inlet conduit 34 upstream from the decompression chamber 35. The external air reaches the inlet of this decompression chamber 35 via a wide port 36 diametrically passing through the cover 3, in an axial position such that this port 36 meets the central conduit of the cover 3 between the outlet of the inlet conduit 36 and the inlet of the decompression chamber 35. This port 36 is wider than the diameter D35 of the decompression chamber 35 such that this port interrupts the central conduit of the cover 3 between the inlet conduit 34 and the decompression chamber 35.

The port 36 replaces the openings provided in the embodiment of FIGS. 19 to 23.

Regardless of the embodiment of the nozzle according to the invention, the parts most susceptible to wear induced by the friction of suspended particles in the fluid to be vaporized at least are preferably made of ceramic. It consists in particular of the calibration swirl 5 and the buffer or diffuser thereof, the conical closing surface of the diffuser on the cover as well as the channels and the discharge disk.

According to the invention, in a nozzle of the type of the nozzle 1 described with reference to the figures, a part with a gyration function, or swirl, is associated with the conventional elements of an air intake nozzle. The swirl is disposed upstream from a core, or cover, having the function of mixing the liquid to be sprayed with air. The swirl is arranged in such a way as to calibrate the flow rate of jet passing through the nozzle, optionally with buffer. Conventional nozzles, for example of the type described in EP 2 952 261 A1, comprises, on the other hand, a nozzle disk or a disk as calibration part of the jet (reference 5 or 33).

The channels of the outlet orifice of a hollow-core nozzle are of dimensions equal to or greater than those of the passage of a nozzle disk of equivalent flow rate. For nozzles of this type, a filtration factor corresponding to the ratio of the mesh size used for the filtering element to the diameter of the calibration orifice is defined. For a nozzle according to the invention, the filtration factor can be defined as the ratio of the mesh size to the width of the narrowest fluid passage of the swirl.

In Table 1, values of the filtration ratio are compiled for nozzles according to the invention (Column IX) linked, each time, with the value of the filtration ratio for a conventional nozzle (Column VI) of equivalent flow rate (Column I, III). A comparison of the filtration factors in relation to the conventional nozzles (Column VI) and the proposed nozzles (Column IX) shows a greater homogeneity of these factors, than with a calibration nozzle disk (Column XIII). This homogeneity is based on the gain in width of the intake channels 56 of the swirl 5, which is the smallest fluid passage dimension. The homogeneity makes it possible to extend the useful range of the filters.

Table 1 also compiles dimensional gain values, concerning a widening of the channels of the calibration swirl, in width (Column X) and height (Column XI), and of the discharge orifice thereof (Column XII) with respect to the diameter of a calibration nozzle disk of equivalent flow rate (Column XIII).

The comparison of the filtration factors of the conventional nozzles (Column VI) and the proposed nozzle (Column IX) shows that it is possible, for flow rate ranges (Column I) less than 015 (Rows 1 to 3), to use a coarser filter with the proposed nozzle, without increasing the risk of clogging in relation to a finer filter used with a conventional nozzle. For the flow rate range 0050 (Table 1, Row 1) for example, the filtration factor of the proposed nozzle (Column IX: 0.24) is greater than that of a conventional nozzle (Column VI: 0.15), whereas the proposed nozzle is associated with a coarser filter (Column VII: mesh 100) than the conventional nozzle (Column III: mesh 200). The proposed nozzle enables the use of a filter of greater size without increasing the risk of clogging this nozzle, i.e., a filter less prone to clogging.

The nozzles adapted to higher flow rates, beyond the range 02 (Rows 5 to 11), have practically no risk of clogging.

TABLE 1

| | I | II | III | IV | V | VI | XIII |
|---|---|---|---|---|---|---|---|
| 1 | 0050 | Purple | 200 | 200 | 0.074 | 0.15 | 0.5 |
| 2 | 0075 | Pink | 300 | 200 | 0.074 | 0.12 | 0.6 |
| 3 | 01 | Orange | 400 | 100 | 0.15 | 0.21 | 0.7 |
| 4 | 015 | Green | 400 | 80 | 0.2 | 0.23 | 0.9 |
| 5 | 02 | Yellow | 600 | 80 | 0.2 | 0.2 | 1.0 |
| 6 | 025 | Lilac | 800 | 50 | 0.36 | 0.32 | 1.1 |
| 7 | 03 | Blue | 1000 | 50 | 0.36 | 0.29 | 1.2 |
| 8 | 04 | Red | 1200 | 50 | 0.36 | 0.25 | 1.5 |
| 9 | 05 | Brown | 1600 | 50 | 0.36 | 0.23 | 1.6 |
| 10 | 06 | Gray | 2000 | 50 | 0.36 | 0.21 | 1.7 |
| 11 | 08 | White | 2400 | 50 | 0.36 | 0.18 | 2.0 |

TABLE 2

| | I | VII | VIII | IX | X | XI | XII |
|---|---|---|---|---|---|---|---|
| 1 | 0050 | 100 | 0.15 | 0.24 | 27 | 51.6 | 66 |
| 2 | 0075 | 100 | 0.15 | 0.24 | 20 | 43.3 | 56.7 |
| 3 | 01 | 80 | 0.2 | 0.22 | 11.3 | 33.8 | 46.5 |
| 4 | 015 | 80 | 0.2 | 0.19 | 5.7 | 26.4 | 37.9 |
| 5 | 02 | 80 | 0.2 | 0.19 | 8 | 30 | 25 |
| 6 | 025 | 50 | 0.36 | 0.31 | 4.5 | 25 | 20.5 |
| 7 | 03 | 50 | 0.36 | 0.29 | 0 | 20.2 | 15.3 |
| 8 | 04 | 50 | 0.36 | 0.25 | 0.3 | 20.4 | 4.5 |
| 9 | 05 | 50 | 0.36 | 0.23 | −0.6 | 19 | 3.8 |
| 10 | 06 | 50 | 0.36 | 0.22 | −4 | 14.9 | 0 |
| 11 | 08 | 50 | 0.36 | 0.19 | −9.9 | 8.1 | −6 |

I: flow rate range as per the standard ISO 10625:2005,
II: color code for the identification of the nozzle according to this standard,
III: flow rate standardized to 3 bar, in cubic centimeters per minute.
IV: filtration conventionally used, mesh size,
V: filtration conventionally used, mesh size, in millimeters,
VI: filtration factor conventionally used,
VII: filtration used with the nozzle according to the invention, mesh size,
VIII: filtration used with the nozzle according to the invention, mesh size, in millimeters,
IX: filtration factor used with the nozzle according to the invention,
X: swirl channel enlargement, in width, in relative terms (percent),
XI: swirl channel enlargement, in height, in relative terms (percent),
XII: discharge orifice enlargement, in diameter, (percent),
XIII: passage orifice diameter of a calibration nozzle disk of equivalent flow rate.

The nozzle consists of removable parts with a view to cleaning maintenance. Gripping can be performed using the nozzle flange composed of three parts belonging to each of the plastic parts of the nozzle: the outer cover, the cover and the nozzle body. The calibration swirl, the buffer or the diffuser and the discharge nozzle disk are preferably made of ceramic. Where applicable, the over-diffuser is also made of ceramic.

A part 7 with a diffuser function equipped with four channels has been described. The number of channels of the diffuser 7 influences the size of the droplets. The number of channels should generally be between 2 and 4. Here, the diffuser 7 has 4 channels which optimizes the velocity of the fluid.

A swirl 5 has been described as a part with a gyration function equipped with two inlet channels 56. A swirl having a different number of channels may be envisaged.

The junction between the decompression chamber 35 and the duct 351 takes the form of a neck 352, of which the radius can be adapted to improve the characteristics of the fluid jet.

The nozzle according to the invention can be devoid of a part with a discharge function such as the disk 8 with reference to the preceding figures. The dimensions of the duct 351, including the neck 352 thereof, are then adapted so as to produce at the nozzle outlet a conical jet wherein the angle at the apex is between 15 and 40 degrees. In this case, the body 2 is optional. The outlet face 12 of the nozzle can correspond to a downstream face of the cover 3. The nozzle produces a spectrum of intermediate (category “M”) to coarse (category “C”) droplets, significantly larger than the spectrum of the isolated swirl 5.

1. Conical-jet spray nozzle (1) comprising
a body (2), of generally axisymmetric shape, with an inlet zone (11) for liquid and an outlet (12), and
a core (3), at least partially housed in the body (2), arranged so as to mix the liquid passing through it with air, upstream from the outlet (12), and
an additional part (5), disposed downstream from the inlet zone (11) and upstream from the core (3), said additional part (5) being arranged so as to gyrate a jet of liquid about an axis (XX′) of the body (2).

2. The nozzle according to claim 1, wherein the additional part (5) comprises a chamber (54), having a revolving shape, and at least one intake channel (56) for liquid, the at least one intake channel (56) opening into the chamber (54) tangentially.

3. The nozzle according to claim 2, wherein the additional part (5) further comprises a discharge conduit (55), wherein the chamber (54) opens axially, and this said discharge conduit (55) having a cross-section dimension each greater than a cross-section dimension of the at least one intake channel (56).

4. The nozzle according to claim 2, wherein said at least one intake channel (56) of the additional part (5) has a cross-section dimension greater than a diameter of a calibration nozzle disk of equivalent flow rate.

5. The nozzle according to claim 4, wherein said at least one intake channel (56) of the additional part (5) has as a minimal cross-section dimension, and said minimal dimension is greater than a diameter of the calibration nozzle disk of equivalent flow rate, by at least ten per cent.

6. The nozzle according to claim 1, wherein the core (3) comprises a decompression chamber (35), capable of mixing a jet of liquid with ambient air, and at least one intake conduit (34) for the liquid, which opens into said decompression chamber (35), the core (3) being disposed relative to the additional part (5) such that the at least one intake conduit (34) of said core (3) is coaxial with an outlet of the additional part (5).

7. The nozzle according to claim 6, wherein the at least one intake conduit (34) of the core (3) has cross-section dimensions less than those of the decompression chamber (35).

8. The nozzle according to claim 7, wherein the intake conduit (34) of the core (3) has cross-section dimensions greater than those of an outlet of the additional part (5).

9. The nozzle according to claim 6, wherein the dimensions of the cross-section of the at least one intake conduit (34) of the core (3) and a length of said intake conduit (34) are chosen together so as to maintain a jet angle at the outlet (12) of approximately 30 degrees.

10. The nozzle according to claim 1, wherein the core (3) further comprises an outlet pipe (351), which flares in the manner of a duct along the axis (XX′) of the body (2), said outlet pipe (351) being dimensioned so as to increase a flaring of the fluid.

11. Nozzle The nozzle according to claim 1, wherein the nozzle is devoid of a part having the function of channeling a tangential velocity of the liquid, at least downstream from the core (3), and further comprising a discharge part (8), housed in the body (2), downstream from the core (3) and upstream from the outlet (12).

12. The nozzle according to claim 11, wherein the discharge part (8) comprises an elongated chamber (83), said chamber (83) has cross-section dimensions and a length adapted according to a desired jet angle at the outlet (12).

13. The nozzle according to claim 1, further comprising a second additional part (7), configured to channel a tangential velocity of the fluid in the second additional part (7), housed in the body (2), downstream from the core (3).

14. The nozzle according to claim 13, further comprising a disk-shaped discharge part (8), downstream from said second additional part (7), said disk-shaped discharge part (8) being housed in the body (2) in such a way that a space is arranged, in said body (2), between the second additional part (7) and the disk-shaped discharge part (8).

15. The nozzle according to claim 14, wherein said space extends over a distance (T) along the axis (XX′) of the body (2) of approximately 1 millimeter.

16. The nozzle according to claim 1, wherein the nozzle is devoid of a discharge part (8) and of a part having the effect of channeling a tangential velocity of the fluid in the jet, wherein the core (3) comprises a part acting as a duct (351; 352) and the dimensions of this duct are adapted so as to produce at the outlet (12) a conical jet having an angle at an apex thereof between 15 and 40 degrees.
